(19) United States
(12) Patent Application Publication
(10) Pub. No.: US 2025/0086160 A1
(43) Pub. Date: Mar. 13, 2025

(54) Parameterized cell data renewal method, device, computer device and storage medium

(71) Applicant: XPEEDIC CO., LTD., SHANGHAI (CN)

(72) Inventors: Liguo JIANG, SHANGHAI (CN); Feng LING, SHANGHAI (CN); Yudong ZHAO, SHANGHAI (CN); Wenliang DAI, SHANGHAI (CN)

(21) Appl. No.: 18/564,519

(22) PCT Filed: Nov. 22, 2022
(86) PCT No.: PCT/CN2022/133379

§ 371 Date: Nov. 27, 2023

(30) Foreign Application Priority Data
Nov. 25, 2021 (CN) 202111408001.6

(51) Int. Cl. G06F 16/23

(52) U.S. Cl. CPC G06F 16/2365

(57) ABSTRACT

The present invention is applicable to the field of layout design and simulation, and provides a parameterized cell data updating method and apparatus, a computer device and a storage medium. The method comprises: determining a target basic primitive according to the state identifier of the basic primitive (S302), wherein the basic primitive is a minimum primitive forming a parameterized cell, the state identifier is used for identifying whether the configuration parameter of the primitive is consistent with attribute data, and the configuration parameter is used for specifying the attribute data of the primitive; updating the attribute data of the target basic primitive according to the configuration parameter (S304); and iteratively updating the attribute data of the parameterized cell according to the attribute data of the target basic primitive (S306).

### TECHNICAL FIELD

The present invention relates to the technical field of layout design and simulation, especially a parameterized cell data renewal method, device, computer device and storage medium.

### BACKGROUND TECHNOLOGY

Process design kit (PDK), is a bridge communicating IC designers, manufacturers and Electronic design automation (EDA) suppliers. Specifically, the PDK is a set of files describing process details of the semiconductors, for use by chip design EDA tools. Before fabrication, the customers usually use the PDK of wafer fabs to ensure that the wafer fabs will produce the chips as per their design, and guarantee the expected functions and performance of the chips. Therefore, before adopting a new semiconductor process, the first thing is to develop a PDK, wherein the PDK defines a set of files reflecting Foundry processes in a language of the manufacturers, is the basis of the designers for physical verification and a key factor dictating success of tape out. In PDK there are Pcell files (Parameterized Cell), describing possible manufacturing methods of transistors (and other elements) for use by the designers in the EDA tools; and Pcells can be regarded as a programmable unit, allowing the users to create instances by defining parameters.

The parameterized cells are variable parameters in EDA software, and are data blocks that can be displayed in real time and be simulated. The Pcells are generated by operating and editing basic graphics primitives, the generated Pcells can be called, when the users create or use the Pcells, properties of the Pcells can be configured, when the configuration parameters of the Pcells change, it is at this time necessary to renew the attribute data of the Pcells to generate the currently required Pcells; in the prior art, during data renewal, it is necessary to update and iterate the basic graphics primitives forming the Pcells one by one to have the Pcell renewed to the latest state.

The renewal process in the prior art is tedious, and when only parameters of several basic graphics primitives in a complex Pcell are changed, the data renew efficiency in the prior art is low.

### SUMMARY OF THE INVENTION

In view of the foregoing problem, it is thus necessary to provide a parameterized cell data renewal method, device, computer device and storage medium.

In one of the embodiment, a parameterized cell data renewal method is provided, wherein the method comprises:
Identifying at least one target basic graphics primitive according to state identifiers of basic graphics primitives, wherein the basic graphics primitives are a smallest graphics primitive forming a parameterized cell, wherein the state identifiers are configured to label whether configuration parameters of the basic graphics primitives are consistent with attribute data, and the configuration parameters are configured to designate the attribute data of graphics primitives;
Renewing the attribute data of the at least one target basic graphics primitive according to the configuration parameters; and
Iterating and renewing the attribute data of the parameterized cell based on the attribute data of the at least one target basic graphics primitive.

In an embodiment, a parameterized unit data renewing device is provided, wherein the device comprises:
A target basic graphics primitive identification module, configured to identify at least one target basic graphics primitive according to state identifiers of basic graphics primitives, wherein the basic graphics primitives are a smallest graphics primitive forming a parameterized cell, the state identifiers are configured to identify whether configuration parameters of graphics primitives are consistent with attribute data, and the configuration parameters are configured to designate the attribute data of the graphics primitives;
A property data renewal module, configured to renew the attribute data of the at least one target basic graphics primitive according to the configuration parameters; and
An iteration and renewal module, configured to iterate and renew the attribute data of the parameterized cell according to the attribute data of the at least one target basic graphics primitive.

In an embodiment, a computer device is provided, wherein the computer device comprises a storage device and a processor, a computer program is stored in the storage device, and the computer program when executed by the processor, will have the processor execute the steps of the parameterized cell data renewal method. In an embodiment, a computer readable storage medium is provided, wherein the computer readable storage medium is stored with a computer program, and the computer program when executed by a processor, will have the processor execute the steps of the parameterized cell data renewal method.

For the parameterized cell data renewal method, device, computer device and storage medium, by introducing the state identifiers of the basic graphics primitives to represent consistency between the configuration data and the attribute data of the basic graphics primitives and find the at least one target basic graphics primitive that is to be renewed and then renew the attribute data of the at least one target basic graphic primitive, renewal of the attribute data of the basic graphics primitives of which the configurations have not been modified is avoided, the renewal speed of the entire parameterized cell is quicker and the renewal efficiency is higher.

### BRIEF DESCRIPTION OF DRAWINGS

FIG. 1 is a structural diagram of a data structure of a parameterized cell in an embodiment;

FIG. 2 is a flowchart diagram of a parameterized cell data renewal method in an embodiment;

FIG. 3 is a flowchart diagram of the parameterized cell data renewal method in an embodiment;

FIG. 4 is a flowchart diagram showing the parameterized cell data renewal method in another embodiment;

FIG. 5 is a flowchart diagram showing the parameterized cell data renewal method in another embodiment;

FIG. 6 is a flowchart diagram showing the parameterized cell data renewal method in another embodiment;

FIG. 7 is a flowchart diagram showing the parameterized cell data renewal method in another embodiment;

FIG. 8 is a flowchart diagram showing the parameterized cell data renewal method in another embodiment;

FIG. 9 is a flowchart diagram showing the parameterized cell data renewal method in another embodiment;

FIG. 10 is a structural diagram of a parameterized cell data renewal device in an embodiment; and

FIG. 11 is an internal structure diagram showing a computer device in an embodiment.

### EMBODIMENTS

To make the purpose, the technical solutions and the advantages of the present invention more clear and apparent, hereinafter a further description will be given to the present invention in conjunction with the accompanying drawings and the embodiments. It shall be understood that, the specific embodiments disclosed herein are only intended to explain the present invention rather than limit the present invention.

It shall be comprehensible that, terms “first”, “second” etc. used in the present invention are only for the purpose of describing the components, however, unless specifically explained, the components are not limited by the terms. These terms are only employed to differentiate the first component from the second component. For example, without departing from the scope of the present invention, the first xx script can be named to be the second xx script and similarly, the second xx script can be named to be the second xx script.

The parameterized cell data renewal method as provided in an embodiment of the present invention can be used in computer devices.

The computer device can be an independent physical server or terminal, can also be a server cluster formed by a plurality of physical servers, and can also be a cloud server providing basic cloud computation services such as cloud servers, cloud databases, cloud storage, CDN etc.

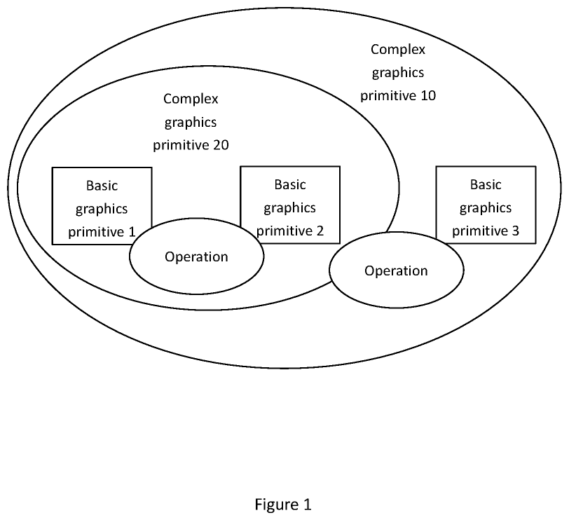

Further, the computer device can run design software, for example EDA software, the EDA software can create parameterized cells and call the parameterized cell, designers can alter the parameters by configuring the parameters of the parameterized cells, the parameterized cells will renew the data after receiving the new configuration data to have a model of the parameterized cells to be as designed. As shown in FIG. 1, the data structure of the parameterized cell in an embodiment is taken as an example. The parameterized cell is a data block with variable parameters, that is, the attribute parameters can be configured, the data structure is a dendritic structure, users can operate on a plurality of graphics primitives to form another graphics primitives, for example, by operating the basic graphics primitive 1 and the basic graphics primitive 2, a complex graphics primitive 20 can be formed, the complex graphics primitive is relative to the basic graphics primitive, and the complex graphics primitives are formed by basic graphics primitives and can also be formed by other complex graphics primitives, the basic graphics primitives are the smallest units that can be configured and operated, and are the smallest graphics primitives that form the parameterized cell, for example, rectangles, circles, or arcs, and properties such as radiuses of the circles and lengths and widths of the rectangles can be configured; and operations on the graphics primitives can be Boolean operations, and geometric operations such as clipping, in the meanwhile, in the newly created complex graphics primitives, the original graphics primitives and operations shall be maintained, for example, in a complex graphics primitive 20 are stored property data and operation data of the basic graphics primitive 1 and the basic graphics primitive 2, thus a dendritic data structure is formed and finally a parameterized cell.

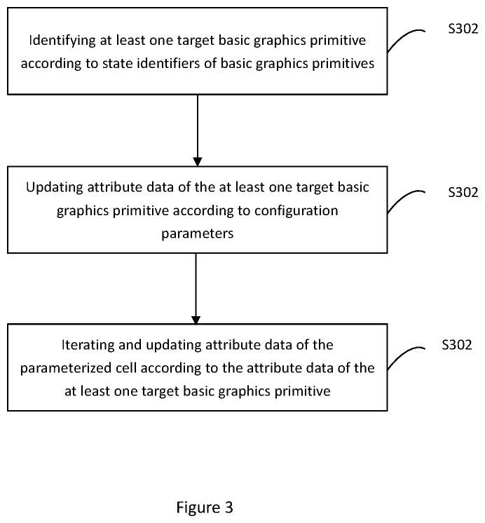

As shown in FIG. 3, in an embodiment, a parameterized cell data renewal method is proposed, and in the present embodiment, an example is given by applying the method in a computer device. Specifically, the method comprises the following steps: Step S302, identifying at least one target graphics primitive according to state identifiers of basic graphics primitives, wherein the basic graphics primitives are the smallest graphics primitives forming a parameterized cell, the state identifiers are configured to identify whether configuration parameters of graphics primitives are consistent with attribute data, and the configuration data are configured to designate the attribute data of the graphics primitives;

Step S304, updating the attribute data of the at least one target graphics primitive according to the configuration parameters; and

Step S306, iterating and renewing the attribute data of the parameterized cell according to the attribute data of the at least one target basic graphics primitive. In an embodiment, a purpose of the renewal is to update the attribute data of the parameterized cell to be consistent with those specified by the users, and when setting the data of the parameterized cell, no matter to change the attribute data of the basic graphics primitives or to change the attribute data of the complex graphics primitives formed by the basic graphics primitives, when being reflected on the data structure, first of all, renew the attribute data of the basic graphics primitives and then iterate and update based on the attribute data of the basic graphics primitives. A state identifier can be introduced in each of the graphics primitives, and the state identifiers can be used to indicate whether the configuration parameters of the graphics primitives are consistent with the current attribute data, if so the configuration parameters of the graphics primitives are consistent with the attribute data, it is not necessary to update the attribute data; if not, the attribute data of the graphics primitives are not consistent with the latest configuration parameters, and the attribute data shall be renewed to be consistent with the configuration data. For the basic graphics primitives, with the state identifiers it can be known whether update of the attribute data for the current basic graphics primitive is necessary, so as to determine the at least one target basic graphics primitive.

In an embodiment, the graphics primitives are configured to form a parameterized cell and comprise nodes of a dendritic structure of the parameterized cell, and the state identifiers can be introduced to both the basic graphics primitives and the complex graphics primitives.

In an embodiment, the basic graphics primitives for which data update is necessary are determined to be the target basic graphics primitives, so as to facilitate updating of the attribute data of these target basic graphics primitives.

In an embodiment, after determining the target basic graphics primitives, update the attribute data of the target basic graphics primitives based on the configuration parameters to be consistent with the configuration parameters, and for the basic graphics primitives that have not been re-assigned parameters it is not necessary to call the update algorithm for update, in this way, the update efficiency is significantly improved and the update time is saved.

In an embodiment, the attribute data of the target basic graphics primitives have been updated to the latest state, and according to the data structure of the parameterized cell, it is further necessary to update the complex graphics primitives formed by the basic graphics primitives. As the data structure of the parameterized cell is determined at the time of creation, relationships between the basic graphics primitives and the complex graphics primitives are determined, between the basic graphics primitives the complex graphics primitives can be generated, and at this time, the basic graphics primitives are the child node graphics primitives, the complex graphics primitives are the parent node graphics primitives, further, the complex graphics primitives can also serve as the child node graphics primitives, and form more complex graphics primitives with other graphics primitives, and at this time the more complex graphics primitives are the parent node graphics primitives. The child node graphics primitives and the parent node graphics primitives are relational, and are used to show the paternity relationships between different graphics primitives, and the paternity relationships can reflect the graphics primitives that a graphics primitive belongs to and graphics primitives that form the graphic primitive. Upon updating of the attribute data of the target basic graphics primitives, the target basic graphics primitives know parent node graphics primitives thereof, the parent node graphics primitives can renew according to the attribute data of the target basic graphics primitives, and apparently, the parent node graphics primitives know other child node graphics primitives of the parent node graphics primitives besides the target basic graphics primitives, and corresponding operation data have been cached therein, and the present embodiment will not limit too much on this. In the present embodiment, by introducing the state identifiers for the basic graphics primitives to represent consistency between the configuration data and the attribute data, and find the target basic graphics primitives to be renewed, renewal of the attribute data of the basic graphics primitives whose configuration has not been changed is avoided, the renewal speed of the entire parameterized cell is quicker and the renewal efficiency is higher.

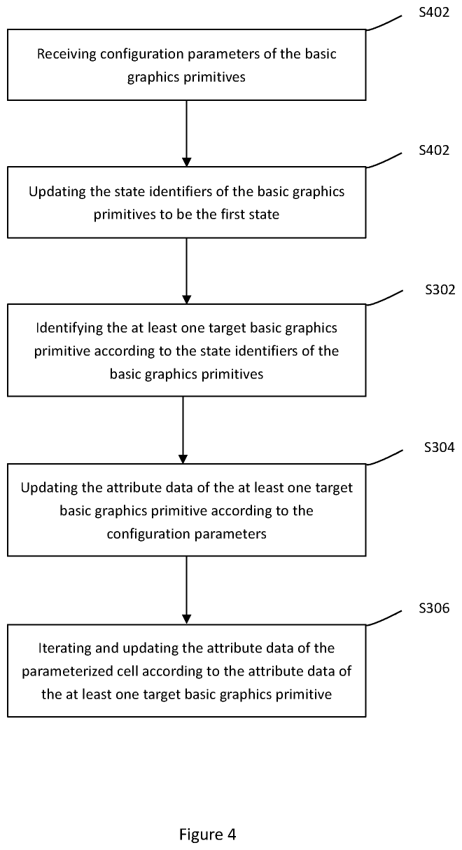

As show in FIG. 4, in an embodiment, in the step S302, the steps before identifying the at least one target basic graphics primitive according to the state identifiers of the basic graphics primitives comprise:

S402, receiving the configuration parameters of the basic graphics primitives; and S404, updating the state identifiers of the basic graphics primitives to be a first state, and the first state is configured to show that the configuration parameters of the graphics primitives are not consistent with the attribute data.

In an embodiment, users set the configuration parameters of the parameterized cell on a software interface, the parameterized cell need to update the data thereof to be consistent with the configuration parameters, as the complex graphics primitives are formed by the basic graphics primitives, both setting the complex graphics primitives and the basic graphics primitives comprises actually setting the basic graphics primitives of the parameterized cell, which requires receiving the parameters that the users set, and renewing first of all the attribute data of the basic graphics primitives.

In an embodiment, upon receiving the configuration data and parameters, with the new configuration data, status change of the state identifiers of the current basic graphics primitives is automatically triggered and the state identifiers of the basic graphics primitives are updated to be the first state to show that the data of the complex graphics primitives shall be renewed too.

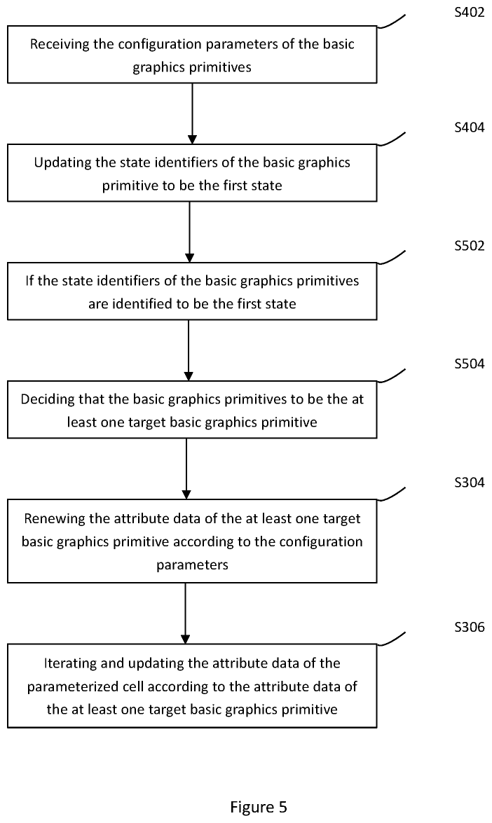

In FIG. 5, in an embodiment, in the step S302, the step of identifying the at least one target basic graphics primitives based on the state identifiers of the basic graphics primitives comprises:

Step S502, marking the states of the basic graphics primitives to be the first state; and

Step S504, recognizing the basic graphics primitives to be the at least one target basic graphics primitive.

In an embodiment, scanning the basic graphics primitives of a parameterized cell, identifying whether the state identifiers of the basic graphics primitives are the first state, if so, the basic graphics primitives are the at least one basic graphics primitives, in the present embodiment, recognizing the states of the basic graphics primitives first so as to facilitate renewal of the attribute data of the at least one target basic graphics primitive, avoid renewal of the data of the basic graphics primitives other than the at least one target graphics primitive, and improve the renewal efficiency; especially, when only data of a few basic graphics primitives are to be renewed, the renewal efficiency can be significantly improved.

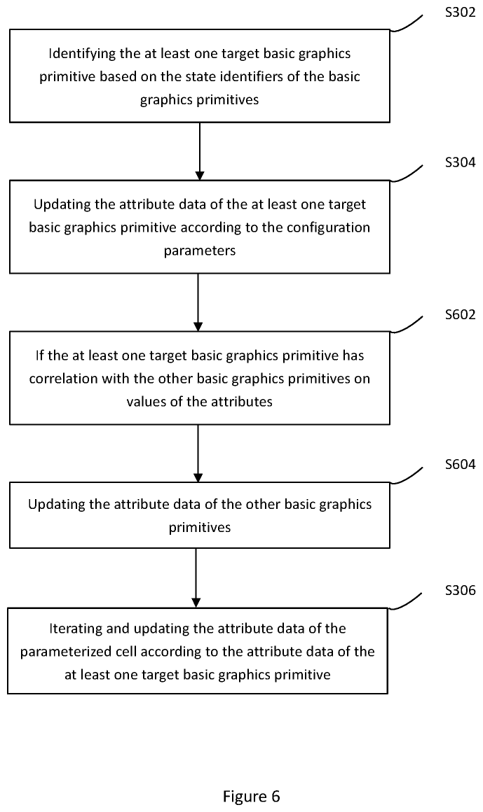

As shown in FIG. 6, in an embodiment, step S306, the steps before iterating and updating the attribute data of the parameterized cell based on the attribute data of the at least one target basic graphics primitive, comprising:

Step S602, when the at least one target basic graphics primitive has a relationship with the other basic graphics primitives on the attribute data;

Step S604, updating the attribute data of the other basic graphics primitives.

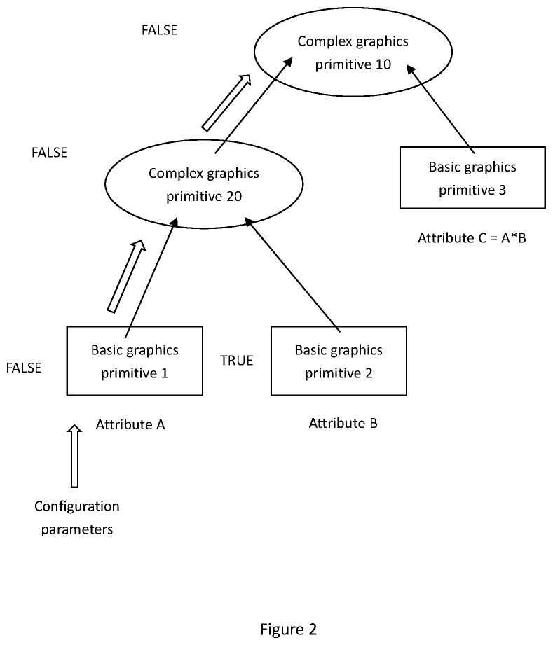

In an embodiment, some of the attribute data of the basic graphics primitives are interrelated, and the relationship is saved in the corresponding basic graphics primitives, when the at least one basic graphics primitive exists in these basic graphics primitives, after updating the data of the at least one target basic graphics primitive, the data of the other graphics primitives that are interrelated shall be forced to update too, so that the basic graphics primitives still satisfy the relationship. For example, in FIG. 2, one of the attributes C of a basic graphics primitive 3 is obtained by multiplying an attribute A of a basic graphics primitive 1 and an attribute B of a basic graphics primitive 2, when attribute values of the attribute A of the basic graphics primitive 1 are to be reassigned and updated, an actual value of the attribute C of the basic graphics primitive 3 is not directly reassigned however will be updated correspondingly.

In an embodiment, by introducing an expression analysis module in the parameterized cell, values of the expression can be analyzed and calculated, relationship restraints can be given to some of the attributes of a plurality of basic graphics primitives, and the restraint attributes can be constant attribute parameters or attribute parameters that can be configured.

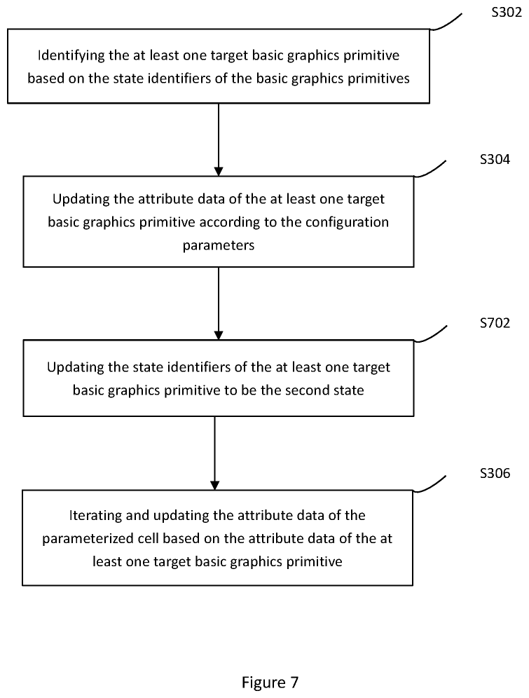

As per FIG. 7, in an embodiment, in step S304, the steps after the step S304, updating the attribute data of the at least one target basic graphics primitive according to the configuration parameters comprises:

Step S702, updating the state identifiers of the at least one target basic graphics primitive to the second state, and the second state is configured to indicate that the configuration parameters of the graphics primitives are consistent with the attribute data.

In an embodiment, after renewing the attribute data of the at least one target basic graphics primitive, the state identifiers thereof shall be updated to be the second state, in both the basic graphics primitives and the complex graphics primitives there are the state identifiers, and for the basic graphics primitives, the second state is configured to show the consistency between the attribute data of the basic graphics primitives and the configuration parameters. In this way, subsequent iteration and renewal can be facilitated and updating of the parameters after data setting can be convenient.

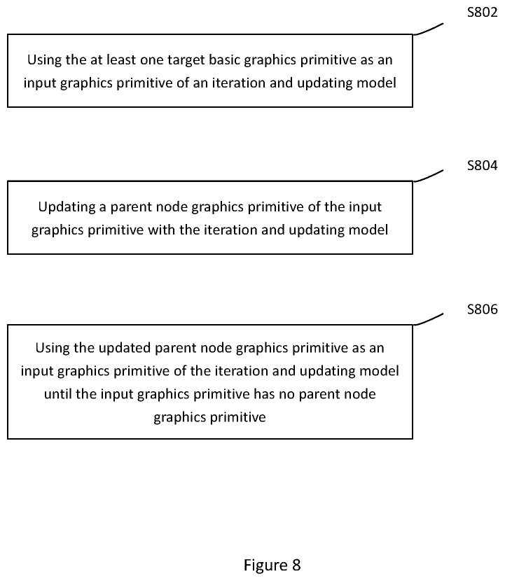

As shown in FIG. 8, in an embodiment, the step S306, iterating and renewing the attribute data of the parameterized cell according to the attribute data of the at least one target basic graphics primitive comprises:

Step S802, using the at least one target basic graphics primitive as input graphics primitives of the iteration and updating model;

Step S804, updating the parent node graphics primitives of the input graphics primitives by the iteration and updating model; and

Step S806, iterating and renewing by using the updated parent node graphics primitives as the input graphics primitives of the iteration and renewal model, until the updated parent node graphics primitives have no parent node graphics primitive existing.

In an embodiment, after renewing the attribute data of the at least one target basic graphics primitive, further data renewal shall be given to the high-layer graphics primitives formed by the at least one target graphics primitive, and conducting updating by an iteration and updating program model. The target basic graphics primitive is the smallest editable graphics primitive, taking the target basic graphics primitive as the input graphics primitive of the iteration and updating model, the parent node graphics primitive of the input graphics primitive is formed by the input graphics primitive and the other graphics primitives, in this way, renewal of the attribute data of the parent node graphics primitive can be done with the data of the input graphics primitive and the other graphics primitives; after updating the parent node graphics primitive, in order to iterate, the parent node graphics primitive is again used as the input graphics primitive, to renew the data of the parent node graphics primitive thereof, iteration is continued until the input graphics primitive does not have any parent node graphics primitive, iteration and renewal of the current target basic graphics primitives is done; the parent node and the child node are relative, and are used to illustrate the relationship between the graphics primitives.

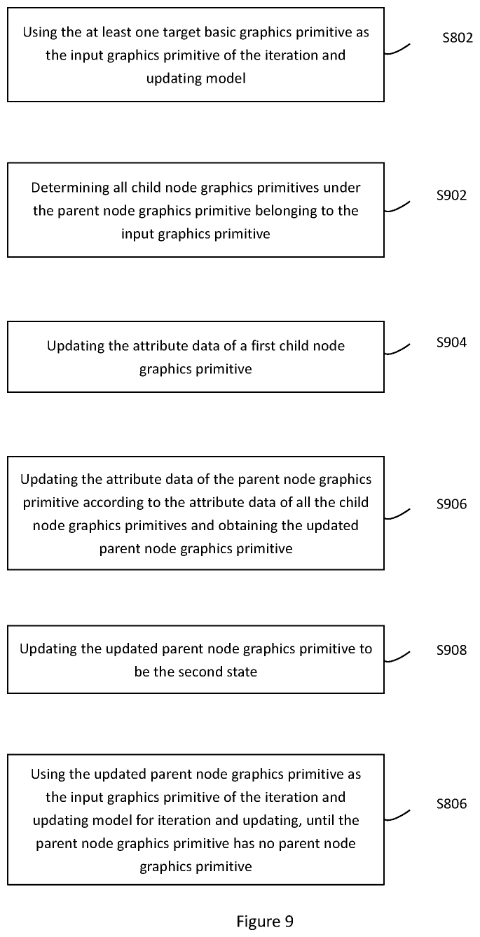

As shown in FIG. 9, the step S804 renewing the parent node graphics primitive of the input graphics primitive with the iteration and updating model comprising: Step S902, determining all child node graphics primitives under the parent node graphics primitive that the input graphics primitive belongs to;

Step S904, renewing the attribute data of at least one first child node graphics primitive, wherein the at least one first child node graphics primitive is the child node graphics primitive in all the child node graphics primitives with the state identifiers the first state;

Step S906, renewing the attribute data of the parent node graphics primitive according to the attribute data of all the child node graphics primitives, and obtaining an updated parent node graphics primitive; and

Step S908, updating the state identifiers of the updated parent node graphics primitive to be the second state.

In an embodiment, first of all, determining all the child node graphics primitives under the parent node graphics primitive that the input graphics primitive belongs to, the paternity relationship is established at the time of creating the parameterized cell, therefore, the parent node graphics primitive knows the child node graphics primitives that form the parent node graphics primitive; determining for which of the child node graphics primitives the data shall be updated, that is, updating of the attribute data is required, and updating those needing data updating to be the at least one first child node graphics primitive; the at least one first child node graphics primitive can be determined from the state identifiers of the child node graphics primitives, and the child node graphics primitives with the state identifiers to be the first state can be directly determined to be the at least one first child node graphics primitive.

Thereafter, renewing the attribute data of the parent node graphics primitive according to the attribute data of the child node graphics primitives, and the state identifier of the updated parent node graphics primitive is updated to be the second state.

In an embodiment, searching the child node graphics primitives of the parent node graphics primitive by the depth-first-search algorithm, determining the child node graphics primitives and determining the data that graphics primitive updating relies on.

In the present embodiment, when to conduct data updating for the parent node graphics primitive, first of all, judging whether the data of the child node graphics primitives require renewal via the states, if so first of all conducting renewal of the attribute data of the child node graphics primitives, so as to avoid another renewal of the parent node graphics primitive after data renewal of the child node graphics primitives, and improve the renewal efficiency.

As shown in FIG. 2, an exemplary explanation of updating the data structure of FIG. 1:

Users have configured the attributes of a basic graphics primitive 1, upon receipt of configuration parameters of the basic graphics primitive 1, state identifiers of the basic graphics primitive 1, a complex graphics primitive 20 and a complex graphics primitive 10 are automatically renewed to be FALSE, that is, the first state, default assignment of the state identifiers of the graphics primitives are TRUE; determining the graphics primitives whose state identifiers are FALSE are the target basic graphics primitives, renewing of the target basic graphics primitives can be done by calling the data renewal algorithm, when conducting data renewal, as the state identifier of the basic graphics primitive 1 is FALSE, the basic graphics primitive 1 is a target basic graphics primitive, renewing the attribute data of the basic graphics primitive 1 according to the configuration parameters, so as to be consistent with the configuration parameters, updating the state identifier of the basic graphics primitive 1 to be TRUE, the second state; and conducting further iteration and renewal based on the updated basic graphics primitive 1.

When conducting iteration and renewal, using the basic graphics primitive 1 as the input graphics primitive of the iteration and updating model, first of all, renewing the parent node graphics primitive thereof, the complex graphics primitive 20, the child node graphics primitives of the complex graphics primitive 20 comprise the basic graphics primitive 1 and the basic graphics primitive 2, checking the state identifiers of the basic graphics primitive 1 and the basic graphics primitive 2, as the basic graphics primitive 1 has been updated, the attribute data of the basic graphics primitive 2 have not been reassigned, the state identifiers of both are FALSE, data of the complex graphics primitive 20 can be renewed directly;

Using the complex graphics primitive 20 as the input graphics primitive of the iteration and updating model, and renewing the parent node graphics primitive of the complex graphics primitive 20, the complex graphics primitive 10; after renewing the complex graphics primitive 10, as there is no further parent node graphics primitive, stopping the iteration.

One possible case is, the state identifier of the complex graphics primitive 20 is detected to be the first state FALSE, showing that, the data of the basic graphics primitives forming the complex graphics primitive 20 are changed, if the attribute data of the basic graphics primitives are renewed, the attribute data of the complex graphics primitive 20 are not renewed, when iterating and renewing the complex graphics primitive 20, it is found that the state identifier of the basic graphics primitive 2 is recognized to be FALSE, first of all, renewing the attribute data of the basic graphics primitive 2, and then renewing the complex graphics primitive 20. Subsequently, the complex graphics primitive 20 and the basic graphics primitives 3 can be used to renew the parent node graphics primitive, the complex graphics primitive 10.

One possible case is that, the attribute C of the basic graphics primitive 3 equals an arithmetic product of an attribute A of the basic graphics primitive 1 and an attribute B of the basic graphics primitive 2, that is, the basic graphics primitive 3 is correlated to the basic graphics primitive 1 and the basic graphics primitive 2, therefore, after renewing the attribute data of the basic graphics primitive 1, the attribute data of the basic graphics primitive 3 shall be forced to renew.

When other target basic graphics primitive exists, iterating and updating via the target basic graphics primitive.

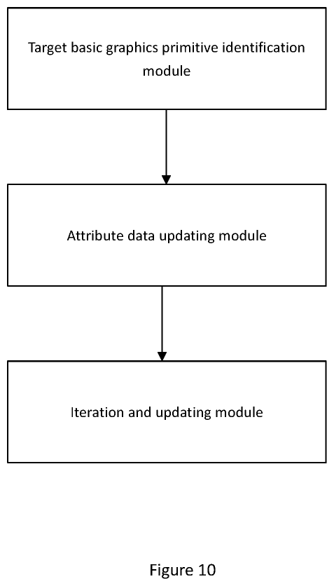

As shown in FIG. 10, in an embodiment, the present invention provides a parameterized cell data updating device, wherein the parameterized cell data updating device can be integrated in the foregoing computer device and comprises specifically:

A target basic graphics primitive identification module, configured to identify the target basic graphics primitives according to state identifiers of the basic graphics primitives, wherein the basic graphics primitives are smallest units forming the parameterized cell, the state identifiers are configured to identify whether the configuration parameters of the graphics primitives are consistent with the attribute data and the configuration parameters are configured to designate the attribute data of the graphics primitives;

An attribute data renewing module, configured to renew the attribute data of the target basic graphics primitives according to the configuration parameters; and

An iteration and updating module, configured to iterate and renew the attribute data of the parameterized cell according to the attribute data of the target basic graphics primitives.

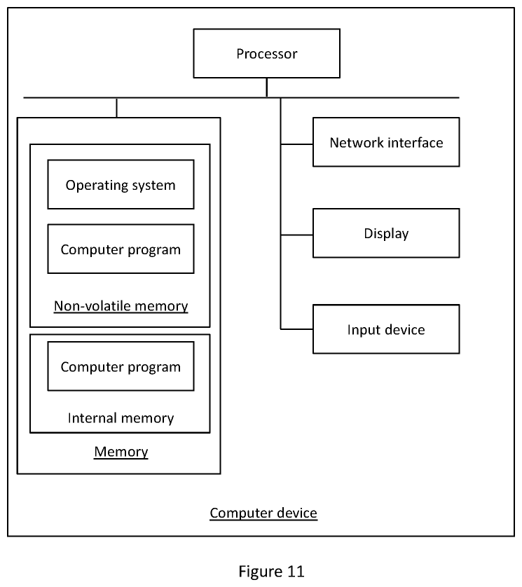

FIG. 11 is an internal structural diagram showing a computer device according to an embodiment of the present invention. As shown in FIG. 11, the computer device comprises a processor, a storage medium, at least one network interface, at least one input device and at least one display. Wherein the storage medium comprises non-volatile storage medium and internal storage devices. An operation system is stored in the non-volatile storage medium of the computer device, and a computer program can be stored therein, the computer program when executed by the processor, will have the processor realize the parameterized cell data renewal method. A computer program is stored in the internal storage device and the computer program when being executed by the processor will have the processor execute the parameterized cell data renewal method. The display of the computer device can be a liquid crystal display or an E-ink display, the at least one input device of the computer device can be a touch layer covered on the display, or keys, a trackball or touch pad provided on a casing of the computer device, and can also be an externally connected keyboard, touch board or mouse.

Those skilled in the art can appreciate that, the structures as shown in FIG. 11 are only diagrams of some of the structures related to the present invention and do not form restrictions on the computer device that the present invention is used thereon, and the specific computer device can include more or less components than as shown in the drawings, or some components can be combined or be configured in different manners.

In an embodiment, the parameterized data renewal device can be implemented in the form of a computer program, and the computer program can be run on the computer device as shown in FIG. 11. The storage medium of the computer device can be stored with program modules that formed the parameterized cell data renewal device, for example, the target basic graphics primitive identification module, the attribute data renewing module and the iteration and updating module. The computer program formed by the program modules can have the processor execute the steps of the parameterized cell data renewal method as shown in the embodiments of the present invention as described herein.

For example, the computer device as shown in FIG. 11 can implement the step S302 via the target basic graphics primitive identification module in the parameterized cell data renewal device as shown in FIG. 10. The computer device can execute the step S304 via the attribute data updating module. The computer device can implement the step S306 via the iteration and updating module. In an embodiment, a computer device is proposed, wherein the computer device comprises a storage device, a processor and a computer program stored in the storage device and can be run by the processor, and the processor executes the computer program and realizes the following steps:
Step S302, identifying at least one target basic graphics primitive according to state identifiers of basic graphics primitives, the basic graphics primitives are a smallest unit forming a parameterized cell, the state identifiers are configured to identify whether configuration parameters of graphics primitives are consistent with attribute data, and the configuration parameters are configured to designate the attribute data of the graphics primitives;
Step S304, updating the attribute data of the basic graphics primitives according to the configuration parameters; and
Step S306, iterating and updating the attribute data of the parameterized cell according to the configuration data of the at least one target basic graphics primitive. In an embodiment, a computer readable storage medium is provided, wherein the computer readable storage medium is stored with a computer program, and the computer program when executed by a processor will have the processor execute the following steps:
Step S302, identifying at least one target basic graphics primitive according to state identifiers of basic graphics primitives, the basic graphics primitives are a smallest unit forming a parameterized cell, the state identifiers are configured to identify whether configuration parameters of graphics primitives are consistent with attribute data, and the configuration parameters are configured to designate the attribute data of the graphics primitives;
Step S304, updating the attribute data of the basic graphics primitives according to the configuration parameters; and
Step S306, iterating and updating the attribute data of the parameterized cell according to the configuration data of the at least one target basic graphics primitive. It shall be understood that, although the steps in the flowchart diagrams of the embodiments of the present invention are shown sequentially as per indications of arrows, the steps are not necessarily executed as per the sequences indicated by the arrows. Unless expressly indicated otherwise, there is no strict sequence restriction on the execution of the steps, and the steps can be executed in other sequences. Furthermore, at least some of the steps in the embodiments can comprises multiple sub-steps or multiple stages, and the sub-steps or stages are not necessarily completed at the same time, but can be executed at different times, and execution sequences of the sub-steps or stages are not necessarily sequential, instead the sub-steps or stages can be alternately executed with other steps or sub-steps or stages of other steps.

Those of ordinary skill in the art can appreciate that the execution of all or some of the processes of the method in the foregoing embodiments can be done by having a computer program instructing corresponding hardware, the program can be stored in a non-volatile computer readable storage medium, and the program when executed, can include the processes of the method embodiments. In the present invention, all citations to storage, storage media, database or other media used in the embodiments can comprise both non-volatile storage devices and/or volatile storage devices. Non-volatile storage devices can include read only memory (ROM), programmable ROM (PROM), electronic programmable ROM (EPROM), electronic erasable programmable ROM (EEPROM) or flash memory. Volatile memory can include random access memory (RAM) and external high speed cache memory. Explanatorily rather than restrictively, the RAM is obtainable in multiple forms, for example, static RAM (SRAM), dynamic RAM (DRAM), synchronous DRAM (SDRAM), double-data-rate SDRAM (DDRSRAM), enhanced SDRAM (ESDRAM), synchlink DRAM (SLDRAM), Rambus direct RAM (RDRAM), direct Rambus dynamic RAM (DRDRAM), Rambus dynamic RAM (RDRAM) etc.

All the technical features in the foregoing embodiments can be combined arbitrarily, and to ease description, not all possible combinations of the technical features in the embodiments are described, however, to the extent that the combinations of the technical features do not conflict, the combinations shall be deemed to be included in the scope of the present invention.

The foregoing embodiments are only some of the embodiments of the present invention, description thereof is concrete and in detail, however, shall not been construed as limitations on the patent scope of the present invention. It shall be pointed out that, for those of ordinary skill in the art, without departing from the essence of the present invention, modifications and improvements are possible and fall into the protection scope of the present invention. Therefore, the protection scope of the present invention shall be defined by the appended claims.

1. A parameterized cell data renewal method, wherein the method comprises:
identifying at least one target basic graphics primitive according to state identifiers of basic graphics primitives, wherein the basic graphics primitives are a smallest graphics primitive forming a parameterized cell, wherein the state identifiers are configured to label whether configuration parameters of the basic graphics primitives are consistent with attribute data, and the configuration parameters are configured to designate the attribute data of graphics primitives;
renewing the attribute data of the at least one target basic graphics primitive according to the configuration parameters; and
iterating and renewing the attribute data of the parameterized cell based on the attribute data of the at least one target basic graphics primitive.

2. The parameterized cell data renewal method according to claim 1, wherein the method further comprises steps before the step of identifying the at least one target basic graphics primitive according to the state identifiers of the basic graphics primitives:
Receiving configuration parameters of the basic graphics primitives; and
Updating the state identifiers of the basic graphics primitives to be a first state, and the first state is configured to indicate the configuration parameters of graphics primitives are not consistent with the attribute data.

3. The parameterized cell data renewal method according to claim 1, wherein the step of identifying the at least one target basic graphics primitive according to the state identifiers of the basic graphics primitives comprises:
When the state identifiers of the basic graphics primitives are the first state;
Identifying the basic graphics primitives to be the at least one basic graphics primitive.

4. The parameterized cell data renewal method according to claim 1, wherein after the step of updating the attribute data of the at least one target basic graphics primitive according to the configuration parameters, the method further comprises:
When the at least one target basic graphics primitive is correlated with other basic graphics primitives on the attribute data;
Updating the attribute data of the other basic graphics primitives.

5. The parameterized cell data renewal method according to claim 2, wherein after the step of updating the attribute data of the at least one target basic graphics primitive according to the configuration parameters the method further comprises:
Updating the state identifiers of the at least one target basic graphics primitive to be a second state and the second state is configured to indicate that the configuration parameters of the basic graphics primitives are consistent with the attribute data.

6. The parameterized cell data renewal method according to claim 5, wherein after the step of iterating and updating the configuration parameters of the parameterized cell according to the configuration parameters of the at least one target basic graphics primitive the method further comprises:
Using the at least one target basic graphics primitive as an input graphics primitive of an iteration and updating model;
Updating a parent node graphics primitive of the input graphics primitive via the iteration and updating model; and
Using the updated parent node graphics primitive as the input graphics primitive of the iteration and updating model until the updated parent node graphics primitive has no parent node graphics primitive.

7. The parameterized cell data renewal method according to claim 1, wherein the step of updating the parent node graphics primitive of the input graphics primitive via the iteration and updating model comprises:
Determining all child node graphics primitives of the parent node graphics primitive that the input graphics primitive belongs to;
Updating attribute data of at least one first child node graphics primitive, wherein the at least one first child node graphics primitive comprises the child node graphics primitives whose state identifiers are marked the first state among all the child node graphics primitives; and
Updating the attribute data of the parent node graphics primitive according to the attribute data of all the child node graphics primitives and obtaining the update parent node graphics primitive; and
Updating the state identifier of the updated parent node graphics primitive to be the second state.

8. A parameterized cell data renewal device, comprises:
A target basic graphics primitive identification module, configured to identify at least one target basic graphics primitive according to state identifiers of basic graphics primitives, wherein the basic graphics primitives are a smallest graphics primitive forming a parameterized cell, the state identifiers are configured to identify whether configuration parameters of graphics primitives are consistent with attribute data, and the configuration parameters are configured to designate the attribute data of the graphics primitives;
An attribute data renewal module, configured to renew the attribute data of the at least one target basic graphics primitive according to the configuration parameters; and
An iteration and renewal module, configured to iterate and renew the attribute data of the parameterized cell according to the attribute data of the at least one target basic graphics primitive.

9. A computer device, wherein the computer device comprises a storage memory and a processor, wherein the storage memory is stored with a computer program, and the computer program when executed by the processor will have the processor to execute the steps of the parameterized cell data renewal method according to claim 1.

10. A computer readable storage medium, wherein a computer program is stored in the computer readable storage medium, and the computer program when being executed by a processor, will have the processor to execute the steps of the parameterized cell data renewal method according to claim 1.
